(19) United States
(12) Patent Application Publication
(10) Pub. No.: US 2014/0327251 A1
(43) Pub. Date: Nov. 6, 2014

(54) DOOR LATCH SECURITY DEVICES AND RELATED METHODS

(71) Applicant: Diamond Heads, LLC, Henderson, NV (US)

(72) Inventor: Keith A. Brinton, Henderson, NV (US)

(21) Appl. No.: 14/262,190

(22) Filed: Apr. 25, 2014

Related U.S. Application Data
(60) Provisional application No. 61/818,639, filed on May 2, 2013.

(51) Int. Cl. E05C 19/18

(52) U.S. Cl. CPC E05C 19/188
USPC 292/277; 29/428

(57) ABSTRACT

Door latch security devices for maintaining doors closed may comprise latch engagement arms configured to obstruct a swinging arm of a door latch from disengaging from a fixed bar of the door latch. A support member may be connected to the latch engagement arms. The support member may be configured to contact the swinging arm of a door latch to support the door latch security device on the door latch. A channel may be defined between the latch engagement arms. The channel may be sized to at least partially receive a swinging arm and a fixed bar of a door latch within the channel.

### CROSS-REFERENCE TO RELATED APPLICATION

This disclosure claims the benefit of the filing date of U.S. Provisional Patent Application Ser. No. 61/818,639, filed May 2, 2013, the disclosure of which is incorporated in this disclosure in its entirety by this reference.

### FIELD

This disclosure relates generally to door latch security devices configured to engage with door latches to maintain a door closed. More specifically, disclosed embodiments relate to door latch security devices that may be portable, may not require any movable parts, and may easily engage with a door latch to maintain the door closed and be removed to enable the door to be opened.

### BACKGROUND

Many doors include a door latch on one side of the door. These door latches may serve as protection against intruders, particularly on doors lacking locks or whose locks are accessible on both sides of the door. A conventional door latch may include a fixed, cantilevered bar having a knob on an end of the bar, which is secured to one of the door and the jamb. The conventional door latch may also include a swinging, cantilevered arm, which may be hingedly secured to the other of the door and the jamb. At the end of the swinging arm nearest its hinged attachment, the swinging arm may include a slot sized to permit the knob to pass through the slot. Along a remainder of the length of the swinging arm, the slot may be sized to permit the fixed bar to pass through the slot and to prevent the knob from passing through the slot. As the fixed bar and swinging arm engage with one another, and particularly as the fixed bar extends through the slot such that the knob engages with the swinging arm, the fixed bar and swinging arm may enable an occupant of the room to open the door part of the way but prevent the door from opening the rest of the way.

Some devices have been made to circumvent swinging arm door latches. For example, U.S. Pat. No. 5,018,415, issued May 28, 1991, for “DOOR SECURITY LATCH OPENER AND METHOD OF USING SAME;” U.S. Pat. No. 5,937,713, issued Aug. 17, 1999, for “TOOL FOR OPENING A DOOR WITH ENGAGED SWING BAR GUARD;” and U.S. Pat. No. 6,802,542, issued Oct. 12, 2004, for “UNLOCKING DEVICE FOR SUPPLEMENTAL DOOR LOCK,” the disclosure of each of which is incorporated in this disclosure in its entirety by these references, each disclose an unlatching device for disengaging the swinging arm from the fixed bar of the door latch.

Some locks that are intended to be portable and to maintain a door shut from one side have also been proposed. For example, U.S. Pat. No. 4,326,394, issued Apr. 27, 1982, for “PORTABLE DOOR LOCK” and U.S. Pat. No. 7,216,902, issued May 15, 2007, for “PORTABLE DOOR LOCK,” the disclosure of each of which is incorporated in this disclosure in its entirety by these references, each disclose a lock that is intended to keep a door shut and to be portable.

### BRIEF SUMMARY

In some embodiments, door latch security devices for maintaining doors closed comprise latch engagement arms configured to obstruct a swinging arm of a door latch from disengaging from a fixed bar of the door latch. A support member may be connected to the latch engagement arms. The support member may be configured to contact the swinging arm of a door latch to support the door latch security device on the door latch. A channel may be defined between the latch engagement arms. The channel may be sized to at least partially receive a swinging arm and a fixed bar of a door latch within the channel.

In other embodiments, methods of making door latch security devices for maintaining doors closed comprise forming a channel between latch engagement arms. The channel may be sized to at least partially insert a swinging arm and a fixed bar of a door latch within the channel. The latch engagement arms may be configured to obstruct a swinging arm of a door latch from disengaging from a fixed bar of the door latch. A support member connected to the latch engagement arms may be configured to contact the swinging arm of a door latch to support the door latch security device on the door latch.

In still other embodiments, methods of using door latch security devices to maintain doors closed comprise at least partially inserting a swinging arm and a fixed bar of a door latch into a channel defined between latch engagement arms to obstruct the swinging arm from disengaging from the fixed bar. A support member connected to the engagement arms may be supported on the door latch to support the door latch security device on the door latch.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a perspective view of a door latch security device;

FIG. 2 is a side view of the door latch security device of FIG. 1;

FIG. 3 is a front view of a door latch security device engaged with a door latch; and

FIG. 4 is a cross-sectional side view of the door latch security device and door latch of FIG. 3.

### DETAILED DESCRIPTION

The illustrations presented in this disclosure are not meant to be actual views of any particular door latch security device, door latch, or component thereof, but are merely idealized representations employed to describe illustrative embodiments. Thus, the drawings are not necessarily to scale.

Disclosed embodiments relate generally to door latch security devices that may be portable, may not require any moving parts, and may easily engage with a door latch to maintain the door closed and be removed to enable the door to be opened. More specifically, disclosed are embodiments of door latch security devices including latch engagement arms and a channel defined between the latch engagement arms, wherein a swinging arm and a fixed arm of a door latch may be at least partially received within the channel, which may enable the latch engagement arms to obstruct the swinging arm from disengaging from the fixed arm.

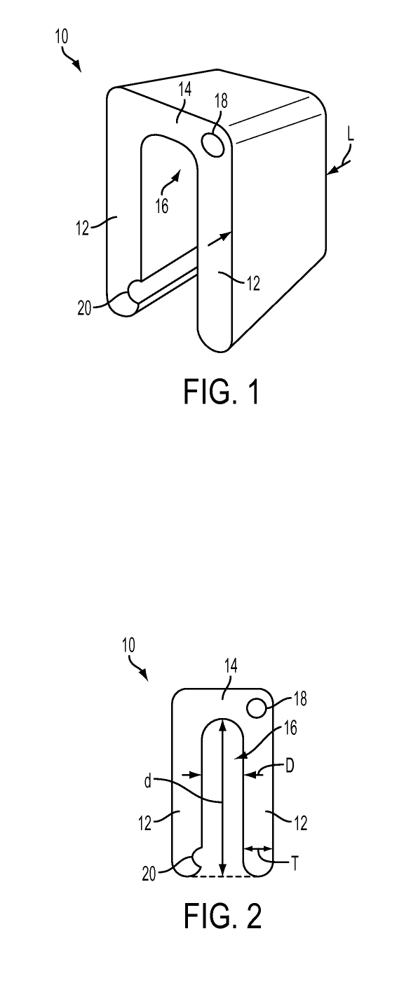

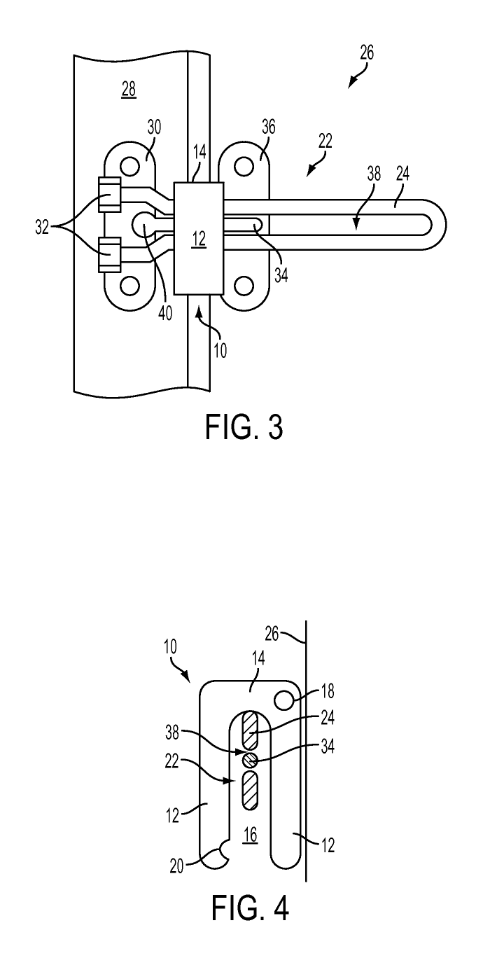

Referring to FIG. 1, a perspective view of a door latch security device 10 is shown. The door latch security device 10 may include latch engagement arms 12 configured to obstruct a swinging arm 24 (see FIGS. 3, 4) of a door latch 22 (see FIG. 3) from disengaging from a fixed bar 34 (see FIGS. 3, 4) of the door latch 22 (see FIG. 3). The door latch security device 10 may further include a support member 14 connected to the latch engagement arms 12. The support member 14 may be configured to contact the swinging arm 24 (see FIGS. 3, 4) of a door latch 22 (see FIG. 3) to support the door latch security device 10 on the door latch 22 (see FIG. 3). The latch engagement arms 12 and the support member 14 may be separate sections of a single, unitary part in some embodiments. In other embodiments, the latch engagement arms 12 and the support member 14 may be separate parts that are connected to one another (e.g., by welds, adhesives, screws, bolts, rivets, pins, etc.) to form the door latch security device 10.

The support member 14 may comprise, for example, a generally horizontally extending span extending between the latch engagement arms 12. The latch engagement arms 12 may comprise, for example, generally vertically extending stanchions extending downward from the support member 14. In some embodiments, the latch engagement arms 12 may extend in a direction perpendicular to the support member 14 and parallel to one another. In other embodiments, one of both of the latch engagement arms 12 may extend at an oblique angle with respect to the support member 14.

A channel 16 may be defined between the latch engagement arms 12 under the support member 14. The channel 16 may be sized to at least partially receive a swinging arm 24 (see FIGS. 3 and 4) and a fixed bar 34 (see FIGS. 3 and 4) of a door latch 22 (see FIG. 3) within the channel 16. The channel 16 may comprise, for example, a space enclosed on three sides by the support member 14 and the latch engagement arms 12 and open on a remaining fourth side to enable the swinging arm 24 (see FIGS. 3 and 4) and the fixed bar 34 (see FIGS. 3 and 4) of the door latch 22 (see FIG. 3) to be at least partially inserted within the channel 16.

The door latch security device 10 may exhibit sufficient structural strength to resist attempts to open a door 26 (see FIG. 3) when the door latch security device 10 is engaged with a door latch 22 (see FIG. 3). The door latch security device 10 may be formed from materials that are, for example, relatively strong and stiff for their weight. For example, the door latch security device 10 may be formed from a metal or metal alloy (e.g., aluminum, steel, titanium, or alloys thereof), a polymer (e.g., high-density polyethylene (HDPE) or polyethylene terephthalate (PET)), or a composite material (e.g., carbon fibers in a polymer matrix, fiberglass, etc.).

A length L of each latch engagement arm 12 as measured in a direction at least substantially parallel to a direction in which a door latch 22 (see FIG. 3) is configured to extend through the channel 16 may be small enough for the door latch security device 10 to be placed on a door latch 22 (see FIG. 3) between its points of attachment to a door 26 (see FIG. 3) and a doorjamb 28 (see FIG. 3) or other adjoining structure, while being sufficiently great for the door latch security device 10 to resist attempts to open a door 26 (see FIG. 3) when placed on the door latch 22 (see FIG. 3). For example, the length L of each latch engagement arm 12 may be between about 0.125 cm and about 7.0 cm. More specifically, the length L of each latch engagement arm 12 may be, for example, between about 1.0 cm and about 2.0 cm (e.g., about 1.3 cm).

Referring to FIG. 2, a side view of the door latch security device 10 of FIG. 1 is shown. A distance D between the latch engagement arms 12 across the channel 16 may be sufficiently great to receive a swinging arm 24 (see FIGS. 3 and 4) and a fixed bar 34 (see FIGS. 3 and 4) of a door latch 22 (see FIG. 3) between the latch engagement arms 12. For example, the distance D between the latch engagement arms 12 may be between about 0.5 cm and about 2.0 cm. More specifically, the distance D between the latch engagement arms 12 may be, for example, between about 0.75 cm and about 1.25 cm (e.g., about 1 cm).

A depth d of the channel 16 as measured from an end of a latch engagement arm 12 to the support member 14 may be sufficiently great to at least partially receive a swinging arm 24 (see FIGS. 3 and 4) and a fixed bar 34 (see FIGS. 3 and 4) of a door latch 22 (see FIG. 3) within the channel 16 such that the latch engagement arms 12 maintain the swinging arm 24 (see FIGS. 3 and 4) engaged with the fixed bar 34 (see FIGS. 3 and 4). For example, the depth d of the channel 16 may be greater than about 2.0 cm. More specifically, the depth d of the channel 16 may be, for example, between about 3.0 cm and about 5.0 cm (e.g., about 4 cm).

A thickness T of each latch engagement arm 12 as measured from a surface of each latch engagement arm 12 facing the channel 16 to a surface of each latch engagement arm 12 opposing the channel 16 may be sufficiently great that each latch engagement arm 12 obstructs a swinging arm 24 (see FIGS. 3 and 4) from disengaging from a fixed bar 34 (see FIGS. 3 and 4) of a door latch 22 (see FIG. 3) when the door latch security device 10 is supported on the door latch 22 (see FIG. 3) and sufficiently small to enable a latch engagement arm 12 to be inserted between the door latch 22 (see FIG. 3) and the door 26 (see FIGS. 3 and 4). For example, the thickness T of each latch engagement arm 12 may be greater than about 0.125 cm. More specifically, the thickness T of each latch engagement arm 12 may be between about 0.5 cm and about 1.0 cm (e.g., about 0.7 cm).

The small size of the door latch security device 10 may enable the door latch security device 10 to be more portable than conventional portable lock devices. In some embodiments, the door latch security device 10 may include an attachment feature 18 configured to enable the door latch security device 10 to connect to another structure for convenience in transporting the door latch security device 10. The attachment feature 18 may comprise, for example, a hole extending through the door latch security device 10, which may enable the door latch security device 10 to be attached to a keychain, a backpack, luggage, or other structure frequently carried by travelers for convenience in transporting the door latch security device 10.

In some embodiments, the door latch security device 10 may include features that render it useful in situations other than securing a door shut. For example, the door latch security device 10 may include a bottle opener 20. The bottle opener 20 may comprise, for example, a groove extending along the length L (see FIG. 1) of one of the latch engagement arms 12 on a side facing the channel 16. The bottle opener 20 may receive a bottle gap within the groove and the other latch engagement arm 12 may provide leverage for a user to open the bottle.

The door latch security device 10 may be formed using conventional manufacturing processes and techniques. For example, the door latch security device may be formed by machining, injection molding, die forming, drilling, cold forming, grinding, polishing, and other manufacturing processes and techniques known in the art. As a specific, nonlimiting process for forming the door latch security device 10, material may be removed from a central portion of a block of the material (e.g., by machining) to a depth d, which may simultaneously form the channel 16, the latch engagement arms 12, and the support member 14. As another specific, nonlimiting process for forming the door latch security device 10, the latch engagement arms 12 may be moved proximate to one another to form the channel 16 and fixed in place, such as, for example, by bending a bar to bring the latch engagement arms 12 toward one another or by contacting the latch engagement arms 12 to the support member 14 and affixing them in place.

Referring to FIG. 3, a front view of a door latch security device 10 engaged with a door latch 22 is shown. The door latch 22 may include a swinging arm 24 hingedly connected to one of a door 26 and a doorjamb 28 (or other adjoining structure). The swinging arm 24 may be hingedly connected to the door 26 or the doorjamb 28, for example, using a faceplate 30 including a hinge 32 to which the swinging arm 24 is connected and about which the swinging arm 24 may rotate. The faceplate 30 may be fixed to the door 26 or the doorjamb 28, for example, using screws, bolts, nails, etc. The door latch 22 may also include a fixed bar 34 attached to the other of the door 26 and the doorjamb 28. The fixed bar 34 may extend from a base plate 36 to which it is rigidly connected. The base plate 36 may be fixed to the door 26 or the doorjamb 28, for example, using any of the fasteners described previously in connection with the faceplate 30.

The swinging arm 24 may define a slot 38 sized to permit the fixed bar 34 to pass through the slot 38. The fixed bar 34 may include a knob 40 at an end of the fixed bar 34 opposing the base plate 36. The slot 38 may be sized to permit the knob 40 to pass through the slot 38 at an end proximate the hinge 32 and to obstruct (e.g., prevent) the knob 40 from passing through the slot 38 along a remainder of the slot 38. When the swinging arm 24 is rotated toward the fixed bar 34 in such a way that the knob 40 is at least partially inserted through the slot 38, opening the door 26 may cause the knob 40 to travel the rest of the way through the slot 38 and engage with the swinging arm 24. Mechanical interference between the swinging arm 24 and the knob 40 may prevent the door 26 from opening beyond an extent at which the fixed bar 34 contacts the swinging arm 24 at the end of the slot 38.

Referring to FIG. 4, a cross-sectional view of the door latch security device 10 and door latch 22 of FIG. 3 is shown. When a user wants more privacy and security than the door latch 22 alone can provide, the user may place the door latch security device 10 on the door latch 22. More specifically, the swinging arm 24 and the fixed bar 34 may be at least partially received in the channel 16 such that the latch engagement arms 12 obstruct the swinging arm 24 from rotating away from the fixed bar 34. One of the latch engagement arms 12 may be inserted between the swinging arm 24 and the door 26 as the door latch security device 10 is placed on the door latch 22. The support member 14 may contact the swinging arm 24 of the door latch 22, and the door latch security device 10 may be supported on the door latch 22 using the support member 14. Mechanical interference between the door latch 22 and the latch engagement arms 12 of the door latch security device may obstruct (e.g., prevent) the swinging arm 24 from disengaging from the fixed bar 34. Because the swinging arm 24 and fixed bar 34 are held in a fixed, engaged relationship by the door latch security device 10, the door 26 may not be opened while the door latch security device 10 remains engaged with the door latch 22. When the user wants to open the door 26 again, the door latch security device 10 may simply be lifted off the door latch 22, freeing the swinging arm 24 to disengage from the fixed bar 34.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventor.

What is claimed is:

1. A door latch security device for maintaining a door closed, comprising:
latch engagement arms configured to obstruct a swinging arm of a door latch from disengaging from a fixed bar of the door latch;
a support member connected to the latch engagement arms, the support member configured to contact the swinging arm of a door latch to support the door latch security device on the door latch; and
a channel defined between the latch engagement arms, the channel being sized to at least partially receive a swinging arm and a fixed bar of a door latch within the channel.

2. The door latch security device of claim 1, wherein a distance between the latch engagement arms is between 0.5 cm and 2.0 cm.

3. The door latch security device of claim 2, wherein the distance between the latch engagement arms is between 0.75 cm and 1.25 cm.

4. The door latch security device of claim 3, wherein the distance between the latch engagement arms is 1 cm.

5. The door latch security device of claim 1, wherein a depth of the channel as measured from an end of an engagement arm to the support member is greater than 2.0 cm.

6. The door latch security device of claim 5, wherein the depth of the channel is between 3.0 cm and 5.0 cm.

7. The door latch security device of claim 1, wherein a thickness of each latch engagement arm as measured from a surface of each latch engagement arm facing the channel to a surface of each latch engagement arm opposing the channel is greater than 0.125 cm.

8. The door latch security device of claim 7, wherein the thickness of each latch engagement arm is between 0.5 cm and 1.0 cm.

9. The door latch security device of claim 1, wherein a length of each latch engagement arm as measured in a direction at least substantially parallel to a direction in which a door latch is configured to extend through the channel is between 0.125 cm and 7.0 cm.

10. The door latch security device of claim 9, wherein the length of each latch engagement arm is between 1.0 cm and 2.0 cm.

11. The door latch security device of claim 1, wherein each latch engagement arm extends in a direction perpendicular to the support member and parallel to the other latch engagement arm.

12. The door latch security device of claim 1, further comprising an attachment feature configured to enable the door latch security device to connect to another structure for convenience in transporting the door latch security device.

13. A method of making a door latch security device for maintaining a door closed, comprising:
forming a channel between latch engagement arms, the channel being sized to at least partially insert a swinging arm and a fixed bar of a door latch within the channel;
configuring the latch engagement arms to obstruct a swinging arm of a door latch from disengaging from a fixed bar of the door latch; and
configuring a support member connected to the latch engagement arms to contact the swinging arm of a door latch to support the door latch security device on the door latch.

14. The method of claim 13, wherein forming the channel between the latch engagement arms comprises removing material between the latch engagement arms to form the channel.

15. The method of claim 13, wherein forming the channel between the latch engagement arms comprises moving the latch engagement arms proximate to one another to form the channel.

16. The method of claim 15, wherein moving the latch engagement arms proximate to one another to form the channel comprises bending the latch engagement arms toward one another to form the channel.

17. The method of claim 13, wherein forming the channel comprises forming the channel to comprise a depth as measured from an end of an engagement arm to the support member of greater than 2.0 cm.

18. A method of using a door latch security device to maintain a door closed, comprising:
at least partially inserting a swinging arm and a fixed bar of a door latch into a channel defined between latch engagement arms to obstruct the swinging arm from disengaging from the fixed bar; and
supporting a support member connected to the engagement arms on the door latch to support the door latch security device on the door latch.

19. The method of claim 18, wherein at least partially inserting the swinging arm and the fixed bar of the door latch into the channel comprises completely inserting the swinging arm and the fixed bar within the channel.

20. The method of claim 18, wherein at least partially inserting the swinging arm and the fixed bar of the door latch into the channel comprises inserting one of the latch engagement arms between the door latch and the door to which the door latch is connected.
